(19) United States
(12) Patent Application Publication
(10) Pub. No.: US 2018/0025725 A1
(43) Pub. Date: Jan. 25, 2018

(54) SYSTEMS AND METHODS FOR ACTIVATING A VOICE ASSISTANT AND PROVIDING AN INDICATOR THAT THE VOICE ASSISTANT HAS ASSISTANCE TO GIVE

(71) Applicant: Lenovo (Singapore) Pte. Ltd., New Tech Park (SG)

(72) Inventors: Ming Qian, Cary, NC (US); Song Wang, Cary, NC (US)

(21) Appl. No.: 15/217,533

(22) Filed: Jul. 22, 2016

(51) Int. Cl. G10L 15/22; H04L 12/28; H05B 37/02; G10L 15/02; G10L 15/18; H04L 29/06; H04L 29/08

(52) U.S. Cl. CPC G10L 15/22; H04L 67/42; H04L 12/2856; H04L 67/02; G10L 15/02; G10L 15/1815; H05B 37/0236; G10L 2015/221

(57) ABSTRACT

A voice assistant of a computer device is activated not by a key word being spoken or button press but by recognizing speech and determining whether context of the speech indicates that audible voice assistance is appropriate. The device may indicate by, e.g., illuminating a lamp or by activating a vibrator that it has assistance to give.

### FIELD

The present application relates generally to systems and methods for activating a voice assistant and providing an indicator that the voice assistant has assistance to give.

### BACKGROUND

As recognized herein, existing voice assistants are reactive in that they are typically activated wither by a user using a voice trigger, or by a button or key manipulation. As understood herein, this requires affirmative user action with specific knowledge either for the correct key or button to manipulate, or for the correct voice trigger, which can be inconvenient and disruptive to the user's other activities.

### SUMMARY

Accordingly, in one aspect a device includes a processor and storage accessible to the processor. The storage bears instructions executable by the processor to receive speech and without receiving a user command to enter voice recognition mode, execute voice recognition on the speech to return plural words. The instructions are executable to, using the plural words as entering argument, access a database to correlate the plural words to ancillary information, and return the ancillary information.

The ancillary information may be output on at least one audio speaker.

In example embodiments, the instructions can be executable to, responsive to correlating the plural words to ancillary information, activate an indicator on the device indicating that ancillary information is available. Responsive to subsequent input to present the ancillary information, the ancillary information is presented, whereas responsive to no subsequent input to present the ancillary information, the ancillary information is not presented.

In example embodiments, the instructions can be executable to receive at least one of a first input associated with headphone output and a second input associated with broadcast output, and responsive to the first input, present the ancillary information on the headphones, and responsive to the second input, present the ancillary information on a broadcast speaker different from the headphone.

In example embodiments, the instructions can be executable to, using the plural words as entering argument, access a calendar database and to determine, using at least a time recognized in the plural words, whether the calendar database includes an activity entry for the time. Responsive to the calendar database indicating an activity entry for the time, the instructions may be executable for outputting the ancillary information. In contrast, responsive to the calendar database not indicating an activity entry for the time, the instructions may be executable for not outputting the ancillary information.

The ancillary information may include an audible indication of the activity entry for the time.

In example embodiments, the instructions can be executable to, using the plural words as entering argument, access a grammar database, determine, using the plural words, whether the grammar database indicates at least one word is missing, and responsive to the grammar database indicating at least one word is missing, return the ancillary information, with the ancillary information including the at least one word.

In example embodiments, the instructions can be executable to, using the plural words as entering argument, access a database, determine, using the plural words, whether the database indicates additional information is associated with the plural words, and responsive to the database indicating additional information is associated with the plural words, return the ancillary information. The ancillary information can include at least some of the additional information.

In another aspect, a computer readable storage medium (CRSM) that is not a transitory signal includes instructions executable by a processor to receive speech, execute voice recognition on the speech to return at least one word, and correlate the at least one word to ancillary information. The instructions are executable to, responsive to correlating the at least one word to ancillary information, activate an indicator indicating that ancillary information is available. Responsive to subsequent input to present the ancillary information, the ancillary information is output, and responsive to no subsequent input to present the ancillary information, the ancillary information is not output.

In another aspect, a method includes activating a voice-response assistant of a computing device not by a key word being spoken or button press but by recognizing speech and determining whether context of the speech indicates that audible voice assistance is appropriate. The method also includes at least one of illuminating a lamp and activating a vibrator that the voice-response assistant has assistance to give without outputting assistance on a speaker until a command to do so is received.

The details of present principles, both as to their structure and operation, can best be understood in reference to the accompanying drawings, in which like reference numerals refer to like parts, and in which:

### BRIEF DESCRIPTION OF THE DRAWINGS

FIG. 1 is a block diagram of an example system in accordance with present principles;

FIG. 2 is an example block diagram of a network of devices in accordance with present principles;

FIG. 3 is a block diagram of an example computerized device that may be implemented by any appropriate device described in FIG. 1 or FIG. 2;

FIG. 4 is a flow chart of an example overall algorithm in accordance with present principles;

FIGS. 5-7 are flow charts of example specific use case algorithms;

FIG. 8 is a screen shot of an example user interface (UI) for implementing the “raise hand” mode and defining private or public output; and

FIG. 9 is a flow chart of example logic related to FIG. 8.

### DETAILED DESCRIPTION

With respect to any computer systems discussed herein, a system may include server and client components, connected over a network such that data may be exchanged between the client and server components. The client components may include one or more computing devices including televisions (e.g., smart TVs, Internet-enabled TVs), computers such as desktops, laptops and tablet computers, so-called convertible devices (e.g., having a tablet configuration and laptop configuration), and other mobile devices including smart phones. These client devices may employ, as non-limiting examples, operating systems from Apple, Google, or Microsoft. A Unix or similar such as Linux operating system may be used. These operating systems can execute one or more browsers such as a browser made by Microsoft or Google or Mozilla or another browser program that can access web pages and applications hosted by Internet servers over a network such as the Internet, a local intranet, or a virtual private network.

As used herein, instructions refer to computer-implemented steps for processing information in the system. Instructions can be implemented in software, firmware or hardware; hence, illustrative components, blocks, modules, circuits, and steps are sometimes set forth in terms of their functionality.

A processor may be any conventional general purpose single- or multi-chip processor that can execute logic by means of various lines such as address lines, data lines, and control lines and registers and shift registers. Moreover, any logical blocks, modules, and circuits described herein can be implemented or performed, in addition to a general purpose processor, in or by a digital signal processor (DSP), a field programmable gate array (FPGA) or other programmable logic device such as an application specific integrated circuit (ASIC), discrete gate or transistor logic, discrete hardware components, or any combination thereof designed to perform the functions described herein. A processor can be implemented by a controller or state machine or a combination of computing devices.

Any software and/or applications described by way of flow charts and/or user interfaces herein can include various sub-routines, procedures, etc. It is to be understood that logic divulged as being executed by, e.g., a module can be redistributed to other software modules and/or combined together in a single module and/or made available in a shareable library.

Logic when implemented in software, can be written in an appropriate language such as but not limited to C# or C++, and can be stored on or transmitted through a computer-readable storage medium (e.g., that is not a transitory signal) such as a random access memory (RAM), read-only memory (ROM), electrically erasable programmable read-only memory (EEPROM), compact disk read-only memory (CD-ROM) or other optical disk storage such as digital versatile disc (DVD), magnetic disk storage or other magnetic storage devices including removable thumb drives, etc.

In an example, a processor can access information over its input lines from data storage, such as the computer readable storage medium, and/or the processor can access information wirelessly from an Internet server by activating a wireless transceiver to send and receive data. Data typically is converted from analog signals to digital by circuitry between the antenna and the registers of the processor when being received and from digital to analog when being transmitted. The processor then processes the data through its shift registers to output calculated data on output lines, for presentation of the calculated data on the device.

Components included in one embodiment can be used in other embodiments in any appropriate combination. For example, any of the various components described herein and/or depicted in the Figures may be combined, interchanged or excluded from other embodiments.

The term “circuit” or “circuitry” may be used in the summary, description, and/or claims. As is well known in the art, the term “circuitry” includes all levels of available integration, e.g., from discrete logic circuits to the highest level of circuit integration such as VLSI, and includes programmable logic components programmed to perform the functions of an embodiment as well as general-purpose or special-purpose processors programmed with instructions to perform those functions.

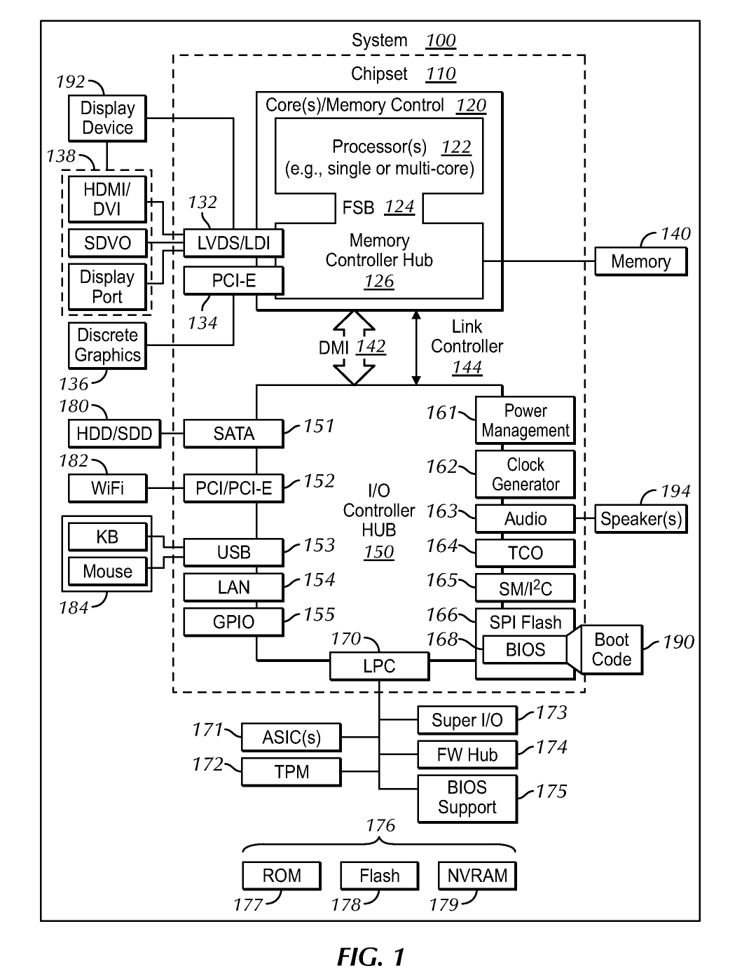

Now specifically in reference to FIG. 1, an example block diagram of an information handling system and/or computer system 100 is shown. Note that in some embodiments the system 100 may be a desktop computer system, such as one of the ThinkCentre® or ThinkPad® series of personal computers sold by Lenovo (US) Inc. of Morrisville, N.C., or a workstation computer, such as the ThinkStation®, which are sold by Lenovo (US) Inc. of Morrisville, N.C.; however, as apparent from the description herein, a client device, a server or other machine in accordance with present principles may include other features or only some of the features of the system 100. Also, the system 100 may be, e.g., a game console such as XBOX®, and/or the system 100 may include a wireless telephone, notebook computer, and/or other portable computerized device.

As shown in FIG. 1, the system 100 may include a so-called chipset 110. A chipset refers to a group of integrated circuits, or chips, that are designed to work together. Chipsets are usually marketed as a single product (e.g., consider chipsets marketed under the brands INTEL®, AMD®, etc.).

In the example of FIG. 1, the chipset 110 has a particular architecture, which may vary to some extent depending on brand or manufacturer. The architecture of the chipset 110 includes a core and memory control group 120 and an I/O controller hub 150 that exchange information (e.g., data, signals, commands, etc.) via, for example, a direct management interface or direct media interface (DMI) 142 or a link controller 144. In the example of FIG. 1, the DMI 142 is a chip-to-chip interface (sometimes referred to as being a link between a “northbridge” and a “southbridge”).

The core and memory control group 120 include one or more processors 122 (e.g., single core or multi-core, etc.) and a memory controller hub 126 that exchange information via a front side bus (FSB) 124. As described herein, various components of the core and memory control group 120 may be integrated onto a single processor die, for example, to make a chip that supplants the conventional “northbridge” style architecture.

The memory controller hub 126 interfaces with memory 140. For example, the memory controller hub 126 may provide support for DDR SDRAM memory (e.g., DDR, DDR2, DDR3, etc.). In general, the memory 140 is a type of random-access memory (RAM). It is often referred to as “system memory.”

The memory controller hub 126 can further include a low-voltage differential signaling interface (LVDS) 132. The LVDS 132 may be a so-called LVDS Display Interface (LDI) for support of a display device 192 (e.g., a CRT, a flat panel, a projector, a touch-enabled display, etc.). A block 138 includes some examples of technologies that may be supported via the LVDS interface 132 (e.g., serial digital video, HDMI/DVI, display port). The memory controller hub 126 also includes one or more PCI-express interfaces (PCI-E) 134, for example, for support of discrete graphics 136. Discrete graphics using a PCI-E interface has become an alternative approach to an accelerated graphics port (AGP). For example, the memory controller hub 126 may include a 16-lane (x16) PCI-E port for an external PCI-E-based graphics card (including, e.g., one of more GPUs). An example system may include AGP or PCI-E for support of graphics.

In examples in which it is used, the I/O hub controller 150 can include a variety of interfaces. The example of FIG. 1 includes a SATA interface 151, one or more PCI-E interfaces 152 (optionally one or more legacy PCI interfaces), one or more USB interfaces 153, a LAN interface 154 (more generally a network interface for communication over at least one network such as the Internet, a WAN, a LAN, etc. under direction of the processor(s) 122), a general purpose I/O interface (GPIO) 155, a low-pin count (LPC) interface 170, a power management interface 161, a clock generator interface 162, an audio interface 163 (e.g., for speakers 194 to output audio), a total cost of operation (TCO) interface 164, a system management bus interface (e.g., a multi-master serial computer bus interface) 165, and a serial peripheral flash memory/controller interface (SPI Flash) 166, which, in the example of FIG. 1, includes BIOS 168 and boot code 190. With respect to network connections, the I/O hub controller 150 may include integrated gigabit Ethernet controller lines multiplexed with a PCI-E interface port. Other network features may operate independent of a PCI-E interface.

The interfaces of the I/O hub controller 150 may provide for communication with various devices, networks, etc. For example, where used, the SATA interface 151 provides for reading, writing or reading and writing information on one or more drives 180 such as HDDs, SDDs or a combination thereof, but in any case the drives 180 are understood to be, e.g., tangible computer readable storage mediums that are not transitory signals. The I/O hub controller 150 may also include an advanced host controller interface (AHCI) to support one or more drives 180. The PCI-E interface 152 allows for wireless connections 182 to devices, networks, etc. The USB interface 153 provides for input devices 184 such as keyboards (KB), mice and various other devices (e.g., cameras, phones, storage, media players, etc.).

In the example of FIG. 1, the LPC interface 170 provides for use of one or more ASICs 171, a trusted platform module (TPM) 172, a super I/O 173, a firmware hub 174, BIOS support 175 as well as various types of memory 176 such as ROM 177, Flash 178, and non-volatile RAM (NVRAM) 179. With respect to the TPM 172, this module may be in the form of a chip that can be used to authenticate software and hardware devices. For example, a TPM may be capable of performing platform authentication and may be used to verify that a system seeking access is the expected system.

The system 100, upon power on, may be configured to execute boot code 190 for the BIOS 168, as stored within the SPI Flash 166, and thereafter processes data under the control of one or more operating systems and application software (e.g., stored in system memory 140). An operating system may be stored in any of a variety of locations and accessed, for example, according to instructions of the BIOS 168.

Additionally, though not shown for clarity, in some embodiments the system 100 may include a gyroscope that senses and/or measures the orientation of the system 100 and provides input related thereto to the processor 122, an accelerometer that senses acceleration and/or movement of the system 100 and provides input related thereto to the processor 122, an audio receiver/microphone that provides input from the microphone to the processor 122 based on audio that is detected, such as via a user providing audible input to the microphone, and a camera that gathers one or more images and provides input related thereto to the processor 122. The camera may be a thermal imaging camera, a digital camera such as a webcam, a three-dimensional (3D) camera, and/or a camera otherwise integrated into the system 100 and controllable by the processor 122 to gather pictures/images and/or video. Still further, and also not shown for clarity, the system 100 may include a GPS transceiver that is configured to receive geographic position information from at least one satellite and provide the information to the processor 122. However, it is to be understood that another suitable position receiver other than a GPS receiver may be used in accordance with present principles to determine the location of the system 100.

It is to be understood that an example client device or other machine/computer may include fewer or more features than shown on the system 100 of FIG. 1. In any case, it is to be understood at least based on the foregoing that the system 100 is configured to undertake present principles.

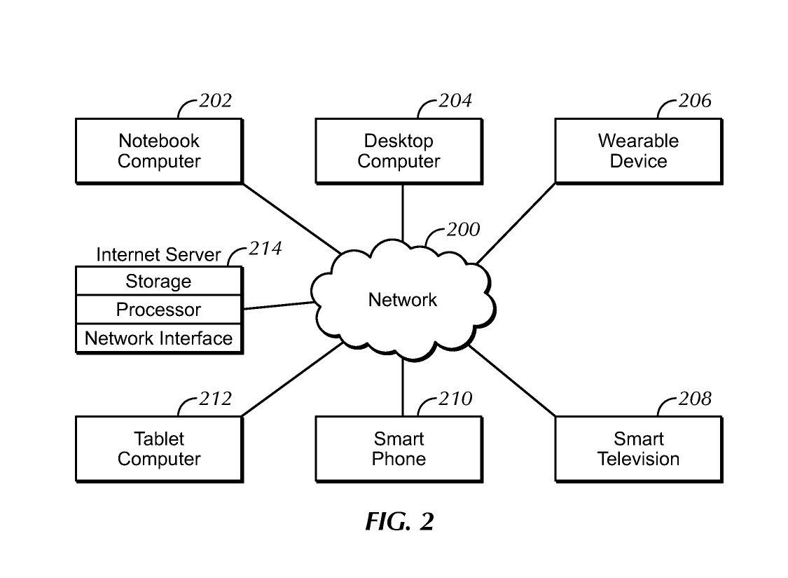

Turning now to FIG. 2, example devices are shown communicating over a network 200 such as the Internet in accordance with present principles. It is to be understood that each of the devices described in reference to FIG. 2 may include at least some of the features, components, and/or elements of the system 100 described above.

FIG. 2 shows a notebook computer and/or convertible computer 202, a desktop computer 204, a wearable device 206 such as a smart watch, a smart television (TV) 208, a smart phone 210, a tablet computer 212, and a server 214 such as an Internet server that may provide cloud storage accessible to the devices 202-212. It is to be understood that the devices 202-214 are configured to communicate with each other over the network 200 to undertake present principles.

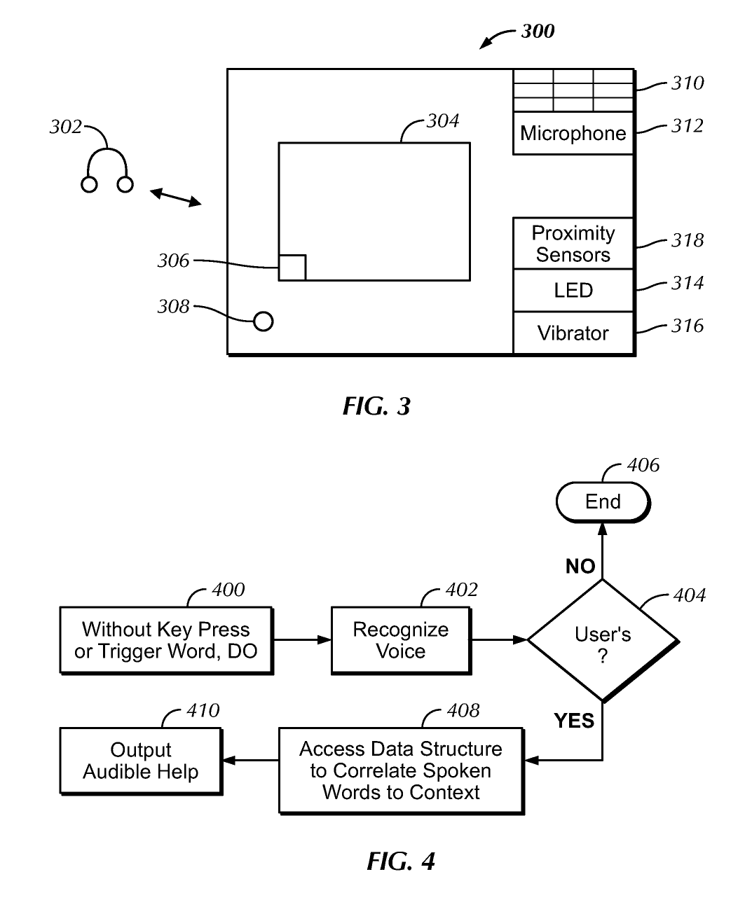

Referring to FIG. 3, a block diagram of an example computerized device 300 is shown that may be implemented by any appropriate device described above. Thus, the device 300 includes one or more of the above-described components as appropriate, including one or more processors and one or more computer storage media.

The device 300 can communicate over a wired and/or wireless link with headphones 302.

The device 300 may include a display 304 such as a touch-sensitive display that may present one or more soft selector keys 306. The device may also include one or more hard selector keys 308, one or more audio speakers 310, and one or more microphones 312. The device 300 may further include one or more indicator lamps 314 such as light emitting diodes (LEDs), one or more tactile signal generators 316 such as a vibrator, and one or more proximity sensors 318 to sense a user's proximity to the device. The proximity sensor may be implemented by an infrared detector whose signal is analyzed by the processor of the device to determine whether a human is proximate (within an IR signal strength threshold, for instance) to the device, or the sensor 318 may be a camera images from which are analyzed by the processor employing face recognition to determine whether a particular person is recognized and based on the size of the image of the face, whether the person is within a proximity threshold of the device.

FIG. 4 illustrates overall logic. Commencing at block 400, without receiving a trigger command from the microphone 312 to enter voice assistant mode and without receiving a voice assistant entry mode command by means of a user pressing one of the selectors 306, 308, the logic moves to block 402 to recognize, using voice recognition principles, one or more spoken words received via the microphone 312. If desired, the logic may proceed to diamond 404 to determine, using voice recognition, whether the voice is that of an authorized user, and if not, the logic may end at state 406.

However, when authorized user voice is enabled and the test at diamond 404 is positive, the logic may move to block 408 to access a data structure (with various examples given below) to correlate the recognized words from speech to a context that typically is associated with ancillary information, i.e., information that is not the same as, but that pertains to, the recognized words. Audible help such as the ancillary information is then output for presentation, typically on the speakers 310 or headphones 302, at block 410.

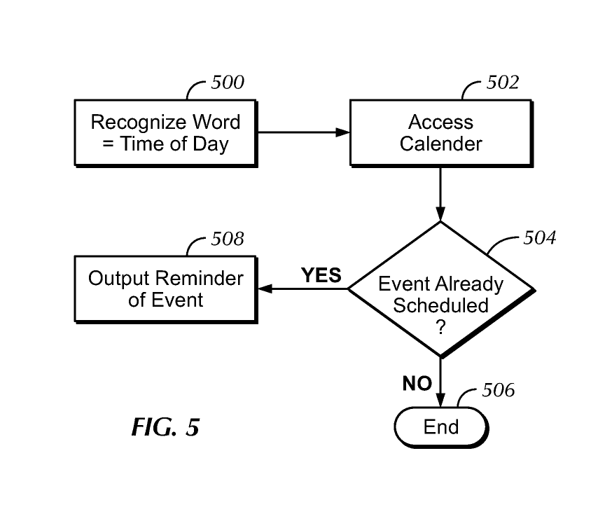

FIG. 5 illustrates an example use case of the logic of FIG. 4. Commencing at block 500, from speech received at the microphone a word is recognized as being a time of day. A particular day may also be recognized, with the default being that if no date is recognized, it is assumed that the spoken time pertains to the current date.

At block 502 an electronic calendar data structure is accessed and based on information in the calendar, it is determined at decision diamond 504 whether an event is already scheduled at the recognized time of day from block 500. If not, the logic may end at state 506, but otherwise the logic can move to block 508 to output, typically audibly on the speakers 310 or headphone 302, a reminder of the event accessed from the calendar at block 502.

Thus, if the user is engaged in a conversation with friend and says “we should have lunch together at 11:30 today at cafeteria”, the algorithm of FIG. 5, in accessing the calendar at 502, might discover that a previous event has been scheduled for the spoken time and thus return, at block 508, a reminder to the effect that “you have a meeting scheduled from 11 AM-1 PM”.

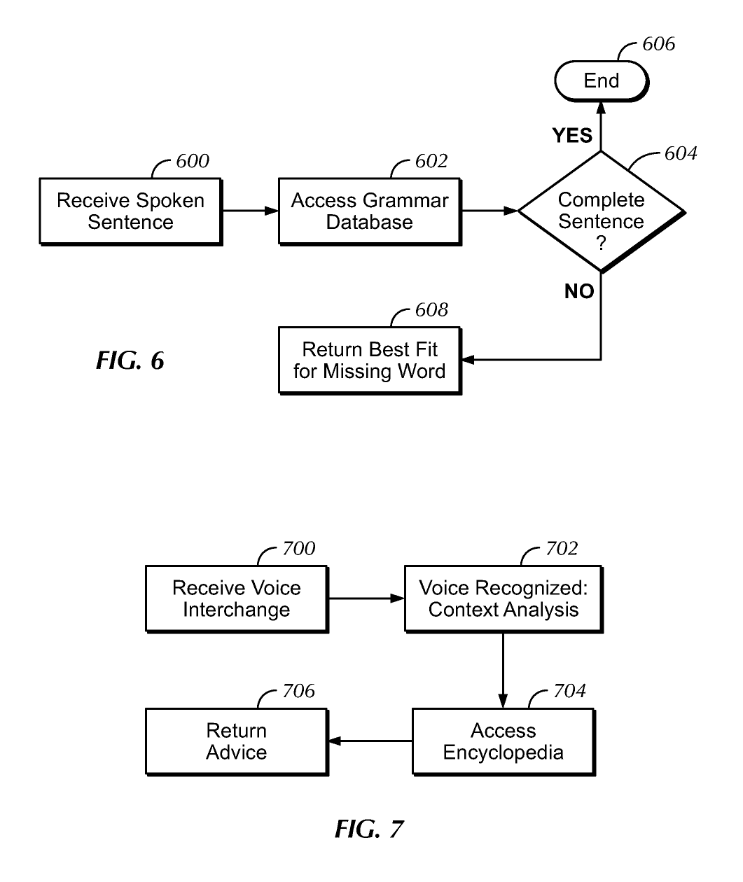

FIG. 6 illustrates another example use case for alleviating lethologica (colloquially referred to as “tip of the tongue”), which is the inability to recall words, phrases, or names. Here the intelligence in an Internet (cloud) data structure can quickly come up with the missing words using the context.

Accordingly, commencing at block 600, a spoken sentence consisting of multiple words is received through the microphone and processed through voice recognition. A grammar database or quote database or other appropriate database may be accessed at block 602 locally and/or in the cloud using the recognized words as entering argument. If it is determined at decision diamond 604 that the recognized words form a complete sentence or if no match is found in the database, the logic may end at state 606.

On the other hand, if the sentence is incomplete/is correlated to assist information in the database, the logic can move to block 608 to return the best fit for the missing word.

As an example, suppose the spoken phrase is “to be, or not to”, and a quotation database is accessed. The spoken phrase would be correlated to the well-known quote from Hamlet and the final word “be” returned at block 608. Yet again, suppose the spoken phrase is “I caught this morning morning's”, which would be correlated to the opening line of the classical poem “The Windhover” to return “minion” at block 608.

FIG. 7 illustrates yet a further use case employed during a voice-interchange (e.g., to negotiate with an opponent, listen to a professor's lecture, etc.) in which the voice assistant established by the present logic executes real-time, continuous content analysis and provides useful advice and knowledge on the fly audibly, including a summary of what was said, detection of the intention of a speaker, detection of misquote, etc.

Commencing at block 700, a voice interchange is received between two people. Voice recognition may be employed not only to detect what words are spoken but also to analyze the different spoken frequencies, timbres, etc. to identify that more than one person is speaking, responsive to some or all of which the logic may move to block 702 to analyze the content of the recognized words. An electronic encyclopedia such as Wikipedia or other data structure may be accessed at block 704 using the recognized speech as entering argument to correlate the recognized speech to ancillary information, which may be returned as advice via the speakers 310 or headphones 302 at block 706.

The data analysis described above can also play a role in the prediction of upcoming events. Most mobile devices today store vast amount of data both on the device and in the cloud. This data can include contact lists, calendar events, alarms, touch events, location/GPS, battery data etc. Machine learning and pattern recognition algorithms can be used to select one or a combination of data to study and learn a user's routine such as the user's working and leisure, daily meeting schedule, etc. The voice assistant can provide useful services such as automatic meeting dial up notification based on the user's work related meeting analysis, and reminders for out of routine activities.

Thus, for the proactive triggering, a user does not need to use a trigger word to activate the assistant, because the assistant logic constantly listens and activates when the logic determines it has input to give. In other words, the assistant is self-triggered.

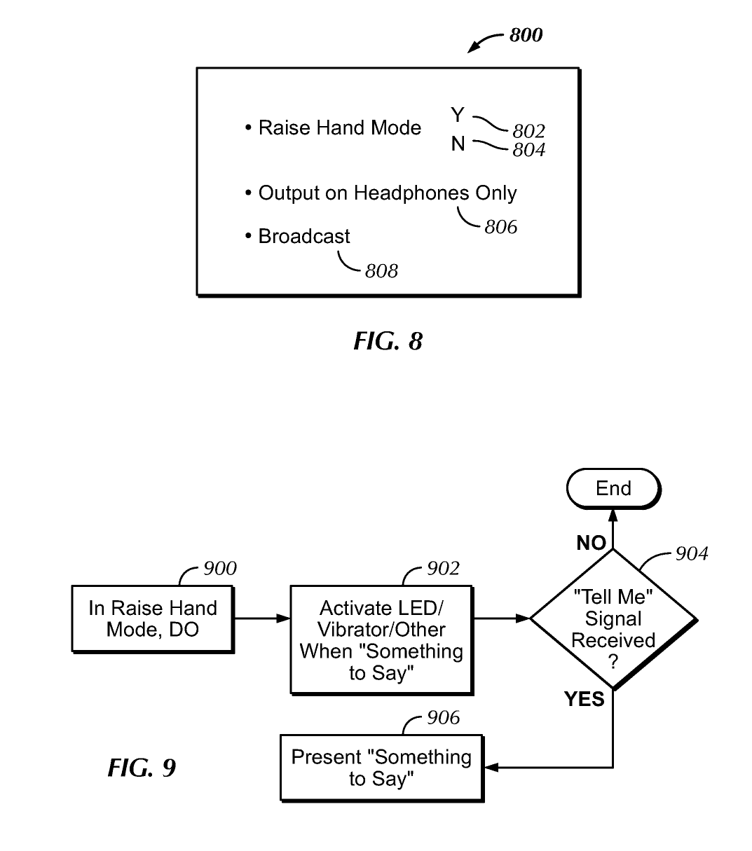

The assistant logic can also have multiple triggering levels (gradually elevated under user control). FIGS. 8 and 9 illustrate.

A user interface (UI) 800 may be presented on, e.g., the display 304 of the device 300 shown in FIG. 3, and may prompt the user to select whether to invoke what is referred to herein for convenience as a “raise hand” mode. A yes selector 802 may be selected to enable the raise hand mode and a no selector 804 may be selected to disable the raise hand mode.

If desired, the user may further be given the option to select levels of assistance privacy. A private selector 806 may be presented as shown which if selected causes audible assistance to be provided on the headphones 302 only, and not on the broadcast speaker 310. In contrast, a public selector 808 may be selected to cause audible assistance to be provided on the broadcast speaker 310 under conditions of non-confidentiality or if the user simply has no self-consciousness.

FIG. 9 illustrates the when the raise hand mode is enabled at block 900, a typically non-audible indicator may be activated at block 902 when the audible assistant has obtained ancillary information according to logic above. For example, the vibrator 316 may be activated to provide tactile signaling that ancillary information is available for audible presentation, or the LED 314 may be illuminated for the same purpose. If desired, however, a subtle beep or other audible signal may be presented on the speaker 310 or headphone 302 to signify that ancillary information is available.

The user can choose to ignore the signal or listen to the advice. In an example, if no “tell me” command is input by the user through any appropriate input means at diamond 904, the ancillary information is not audibly presented. However, responsive to receiving a tell me command, the logic moves to block 906 to present the ancillary information typically on the speakers 310 or headphones 302.

Before concluding, it is to be understood that although a software application for undertaking present principles may be vended with a device such as the system 100, present principles apply in instances where such an application is downloaded from a server to a device over a network such as the Internet. Furthermore, present principles apply in instances where such an application is included on a computer readable storage medium that is being vended and/or provided, where the computer readable storage medium is not a transitory signal and/or a signal per se.

It is to be understood that whilst present principals have been described with reference to some example embodiments, these are not intended to be limiting, and that various alternative arrangements may be used to implement the subject matter claimed herein. Components included in one embodiment can be used in other embodiments in any appropriate combination. For example, any of the various components described herein and/or depicted in the Figures may be combined, interchanged or excluded from other embodiments.

What is claimed is:

1. A device, comprising:
a processor; and
storage accessible to the processor and bearing instructions executable by the processor to:
receive speech;
without receiving a user command to enter voice recognition mode, execute voice recognition on the speech to return plural words;
using the plural words as entering argument, access a database to correlate the plural words to ancillary information; and
return the ancillary information.

2. The device of claim 1, comprising at least one audio speaker, wherein the ancillary information is output on the at least one audio speaker.

3. The device of claim 1, wherein the instructions are executable by the processor to:
responsive to correlating the plural words to the ancillary information, activate an indicator on the first device indicating that ancillary information is available;
responsive to subsequent input to present the ancillary information, present the ancillary information at the first device; and
responsive to no subsequent input to present the ancillary information, not present the ancillary information at the first device.

4. The device of claim 1, wherein the instructions are executable by the processor to:
receive at least one of a first input associated with headphone output and a second input associated with broadcast output;
responsive to the first input, present the ancillary information on the headphones; and
responsive to the second input, present the ancillary information on a broadcast speaker different from the headphone.

5. The device of claim 1, wherein the instructions are executable by the processor to:
using the plural words as entering argument, access a calendar database;
determine, using at least a time recognized in the plural words, whether the calendar database comprises an activity entry for the time;
responsive to the calendar database indicating an activity entry for the time, output the ancillary information; and
responsive to the calendar database not indicating an activity entry for the time, not output the ancillary information.

6. The device of claim 5, wherein the ancillary information comprises an audible indication of the activity entry for the time.

7. The device of claim 1, wherein the instructions are executable by the processor to:
using the plural words as entering argument, access a grammar database;
determine, using the plural words, whether the grammar database indicates at least one word is missing; and
responsive to the grammar database indicating at least one word is missing, return the ancillary information, the ancillary information comprising the at least one word.

8. The device of claim 1, wherein the instructions are executable by the processor to:
using the plural words as entering argument, access a database;
determine, using the plural words, whether the database indicates additional information is associated with the plural words; and
responsive to the database indicating additional information is associated with the plural words, return the ancillary information, the ancillary information comprising at least some of the additional information.

9. A computer readable storage medium (CRSM) that is not a transitory signal, the computer readable storage medium comprising instructions executable by a processor to:
receive speech;
execute voice recognition on the speech to return at least one word;
correlate the at least one word to ancillary information;
responsive to correlating the at least one word to ancillary information, activate an indicator indicating that ancillary information is available;
responsive to subsequent input to present the ancillary information, output the ancillary information; and
responsive to no subsequent input to present the ancillary information, not output the ancillary information.

10. The CRSM of claim 9, wherein the instructions are executable by the processor to:
receive a first input associated with headphone output and a second input associated with broadcast output, and responsive to the first input, present the ancillary information on the headphones, and responsive to the second input, present the ancillary information on a broadcast speaker different from the headphone.

11. The CRSM of claim 9, wherein the instructions are executable by the processor to:
using plural words as entering argument, access a database to correlate the plural words to ancillary information; and
return the ancillary information.

12. The CRSM of claim 9, wherein the ancillary information is output on at least one audio speaker.

13. The CRSM of claim 9, wherein the instructions are executable by the processor to:
using plural words as entering argument, access a calendar database;
determine, using at least a time recognized in the plural words, whether the calendar database comprises an activity entry for the time;
responsive to the calendar database indicating an activity entry for the time, outputting the ancillary information; and
responsive to the calendar database not indicating an activity entry for the time, not outputting the ancillary information.

14. The CRSM of claim 13, wherein the ancillary information comprises an audible indication of the activity entry for the time.

15. The CRSM of claim 9, wherein the instructions are executable by the processor to:
using the at least one word as entering argument, access a grammar database;
determine, using the at least one word, whether the grammar database indicates at least one word is missing; and
responsive to the grammar database indicating at least one word is missing, return the ancillary information, the ancillary information comprising the at least one word that is missing.

16. The CRSM of claim 9, wherein the instructions are executable by the processor to:
using plural words as entering argument, access a database;
determine, using the plural words, whether the database indicates additional information is associated with the plural words; and
responsive to the database indicating additional information is associated with the plural words, return the ancillary information, the ancillary information comprising at least some of the additional information.

17. A method, comprising:
activating a voice-response assistant of a computing device not by a key word being spoken or button press but by recognizing speech and determining whether context of the speech indicates that audible voice assistance is appropriate; and
at least one of illuminating a lamp and activating a vibrator that the voice-response assistant has assistance to give without outputting assistance on a speaker until a command to do so is received.

18. The method of claim 17, comprising:
allowing a user to select a private audible mode and a public audible mode, wherein responsive to selection of the private audible mode assistance is presented on headphones, and wherein responsive to selection of the public audible mode assistance is provided on a speaker of the computing device.

19. The method of claim 17, comprising:
using plural words from the speech as entering argument, accessing a database to correlate the plural words to information; and
returning the information and providing the information at a device as at least a portion of the assistance.

20. The method of claim 19, wherein the instructions are executable by the processor to:
determine that voice assistance is appropriate based at least in part on identification of the speech as being associated with a particular user.
